(19) United States
(12) Patent Application Publication
(10) Pub. No.: US 2013/0285879 A1
(43) Pub. Date: Oct. 31, 2013

(54) ANTENNA

(71) Applicant: Theodore J. WHEELER, Roseville, CA (US)

(72) Inventor: Theodore J. WHEELER, Roseville, CA (US)

(21) Appl. No.: 13/460,591

(22) Filed: Apr. 30, 2012

(51) Int. Cl. H01Q 1/38; H01Q 5/01; B32B 37/12; H01Q 21/00

(52) U.S. Cl. 343/893; 343/700 MS; 156/60

(57) ABSTRACT

An antenna includes an active antenna layer, a ground layer, and a dielectric layer sandwiched between the active antenna and the ground layers. The antenna is bendable to conform to a contour of a surface on which the antenna is positioned.

### BACKGROUND

Antennas generally include a three-dimensional configuration that can often limit the different ways an antenna can be applied onto a surface. For surfaces including varying contours, the different possibilities of antenna application become even further limited. These factors can negatively impact use and performance characteristics of an antenna.

### BRIEF DESCRIPTION OF DRAWINGS

Features of the present disclosure are illustrated by way of example and not limited in the following figure(s), in which like numerals indicate like elements, in which:

FIG. 1A illustrates an architecture of an antenna including multiple coaxial cable connections, according to an example of the present disclosure;

FIG. 1B illustrates an architecture of the antenna including heat or lamination to adhere the metal and dielectric layers, according to an example of the present disclosure;

FIG. 1C illustrates an architecture of the antenna including metal-impregnated or metalized fabric layers, according to an example of the present disclosure;

FIG. 2 illustrates an architecture of the antenna including multiple-input and multiple-output (MIMO) chains, according to an example of the present disclosure;

FIG. 3 illustrates an architecture of the antenna including multiple switched single-input single-output (SISO) antennas, according to an example of the present disclosure;

FIG. 4 illustrates an architecture of the antenna including multiple frequency bands, according to an example of the present disclosure;

FIGS. 5A-5F illustrate top views of architectures of the active antenna elements of the antenna depicted in any of FIGS. 2-4 including various shapes and patterns that may be formed, for example, on any of the active antenna metal layers, according to an example of the present disclosure;

FIG. 6 illustrates top views of architectures of the active antenna elements of the antenna depicted in any of FIGS. 2-4 including various fractal patterns that may be formed, for example, on any of the active antenna metal layers, according to an example of the present disclosure;

FIGS. 7A-7D illustrate top views of architectures of the active antenna elements of the antenna depicted in any of FIGS. 2-4 including various interleaved, orthogonal and stacked configurations that may be formed, for example, on any of the active antenna metal layers, according to an example of the present disclosure; and

FIGS. 8A-8F illustrate top views of architectures of the active antenna elements of the antenna depicted in any of FIGS. 2-4 including various interleaved configurations that may be formed, for example, on any of the active antenna metal layers, according to an example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

An antenna may include a coaxial cable connected to an antenna sandwich. The coaxial cable may include a center active conductor and an outer return path conductor. In an example of a three-layer antenna sandwich, the antenna sandwich may include a dielectric layer sandwiched between metallic top and bottom layers. For a configuration for which the antenna sandwich is flexible, the antenna sandwich may be rolled for shipping and/or storage. In addition, the layers of the antenna sandwich may be attached to each other in any of a variety of different manners as discussed herein below.

The top layer may be formed of a flexible metalized film. For example, the top layer may be formed of brass, copper mylar, etc. The top layer may form an active antenna layer, with an antenna pattern printed thereon. The dielectric layer may be formed of a flexible material including a low-dielectric constant. For example, the dielectric layer may be formed of an air-filled low dielectric-constant low-loss plastic foam. For example, the dielectric layer may be formed of a double stick foam tape for maintaining metal layer distances (i.e., distances between the top and bottom layers for the example of the three-layer antenna sandwich). The dielectric layer may also be formed of hard glass, aerogel, or flexible specialty glass dielectric. In addition, the bottom layer may be formed of a flexible metallized film. For example, the bottom layer may be formed of brass, copper mylar, etc. The bottom layer may form the ground layer.

An aesthetic layer may be added on any exposed sides of the top and/or bottom layers and may also be flexible to match the contour of the top and/or bottom layers. The aesthetic layer may be formed of any suitable material, such as, plastic, polymer, nylon, wood, metal, etc., and may have any suitable solid color or pattern. In addition, or alternatively, the aesthetic layer may also be formed of a transparent material. According to an example, the aesthetic layer may be designed to match a surrounding environment, such as, surrounding artwork, advertising material, etc.

The active antenna elements, for instance, formed in the top layer of the antenna may be shaped in a variety of geometrical shapes and/or patterns. For example, the antenna may include circular, triangular, square, rectangular, octagonal, pentagon, hexagonal, etc., shapes. The patterns may enable the antenna to operate at different frequencies. For example, the antenna may include a 2.4 GHz band pattern on one half, and a 5-6 GHz band pattern on the other half. The antenna may generally include two or more printed antenna pattern copies around each side of a perimeter shape for each multiple-input and multiple-output (MIMO) 802.11n/ac chain connection for symmetry. The antenna may also include interleaved 2.4 GHz and 5-6 GHz shapes when shapes are printed around the perimeter for increased isolation. The antenna may also include repeating or fractal antenna patterns, which may include various connected and/or disconnected shapes. For a fractal pattern, the pattern may be selected based on aesthetic and functional aspects.

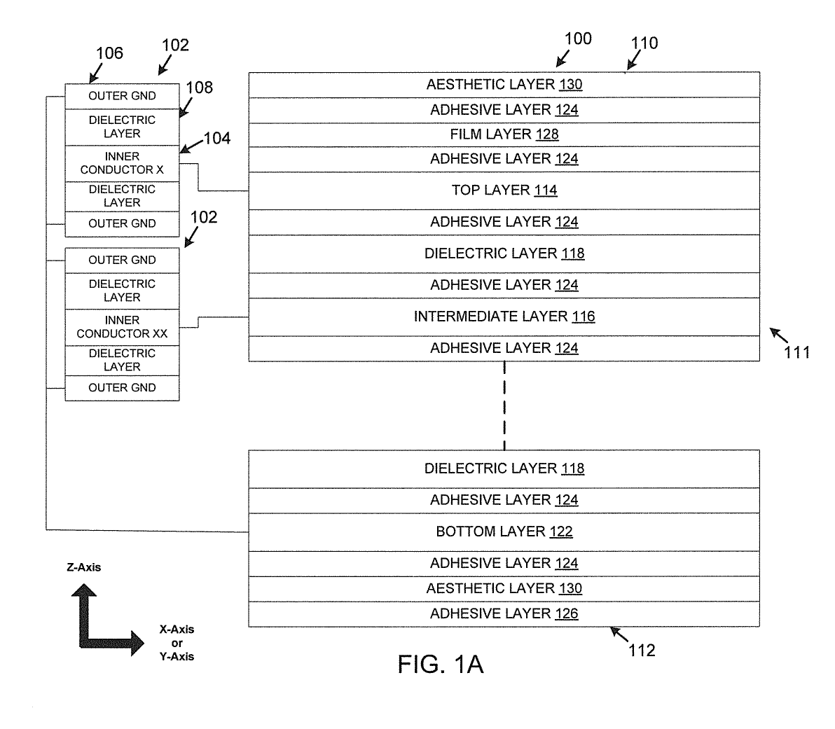

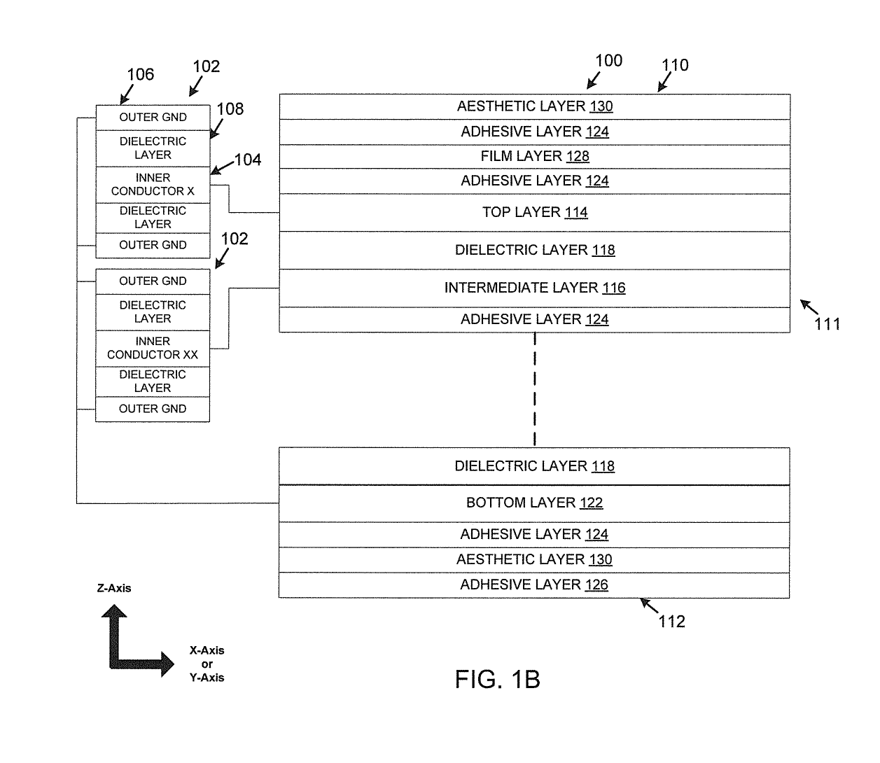

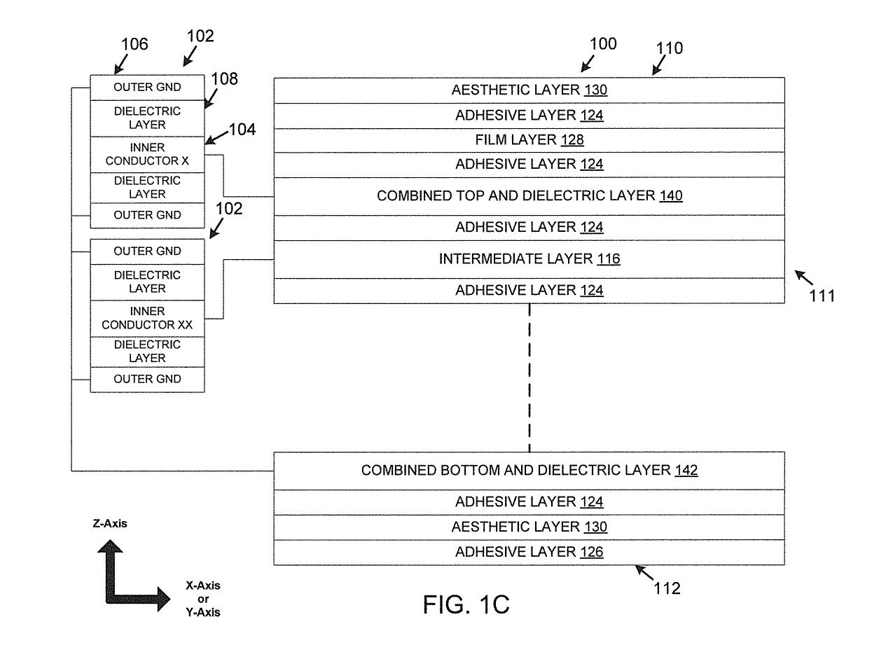

FIG. 1A illustrates an architecture of an antenna 100, according to an example of the present disclosure. The antenna 100 is shown in a z-axis orientation facing upwards, and the x or y-axis facing towards the right for facilitating the description thereof. The orientation of the antenna may be changed as needed.

The antenna 100 is depicted as including a top section 110, an intermediate section 111, and a bottom section 112. The top section 110 comprises the portion of the antenna 100 that is to be visible and to thus face outwards towards an environment in which the antenna 100 (i.e., in the positive z-axis direction) is to be employed. The bottom section 112 comprises the portion of the antenna 100 that is to be mounted onto an object (not shown) and to thus face inwards towards a surface of the object on which the antenna 100 is to be mounted (i.e., in the negative z-axis direction). In addition, the intermediate section 111 comprises an optional portion of the antenna 100 provided between the top section 110 and the bottom section 112. In one regard, the top section 110, the intermediate section 111, and the bottom section 112 are composed of flexible materials and therefore the antenna 100 may conform to a contoured shape of the object on which it is mounted or may otherwise be contoured into a desired shape.

The antenna 100 is also depicted as being electrically connected to multiple coaxial cables 102. Particularly, a first coaxial cable 102 is depicted as being electrically connected to the top section 110 and a second coaxial cable 102 is depicted as being electrically connected to the intermediate section 111. Alternatively, however, a single coaxial cable 102 may be connected to multiple sections 110, 111, 112 of the antenna 100. In any regard, the coaxial cables 102 may include an inner active conductor 104 and an outer return ground conductor 106 that is separated by a dielectric material 108. The coaxial cable 102 may also include a multiconductor coaxial cable, which may include multiple inner conductors (e.g., concentric or side by side) and an external return ground conductor.

The top section 110 is depicted as including a top layer 114, which may be formed of a flexible metalized film. For example, the top layer 114 may be formed of brass, copper mylar, etc. In addition or alternatively, the top layer 114 may be formed as a thin plated metal or a metal foil layer. The top layer 114 may also be formed of a metal deposition layer, such as a mirror. In any regard, the top layer 114 may form an active antenna layer, with active antenna elements having various patterns and/or shapes, as discussed in greater detail herein below.

The intermediate section 111 is depicted as including an intermediate layer 116. The intermediate layer 116 may also be formed of a flexible metallized film, and may comprise any of the materials discussed above with respect to the top layer 114. The dashed line between the intermediate section 111 and the bottom section 112 generally denotes that any suitable number of intermediate sections 111 may be provided in the antenna 100. According to an example, the number of intermediate layers 116 corresponds to the number of coaxial cables 102 that the antenna 100 is to receive. Thus, for a single coaxial cable structure, the antenna 100 may include a top layer 114 and a bottom layer 122, without any intermediate layers 116. In addition, or alternatively, the number of intermediate layers 116 in the antenna 100 may be based upon, for instance, a desired signal strength of the antenna 100, a number of frequency bands in which the antenna 100 is to be operated, antenna design parameters such as gain, number of active antenna elements, etc.

The bottom section 112 is depicted as including a bottom layer 122, which is also referred to herein as a ground layer 122. The bottom layer 122 may also be formed of the flexible metallized film, and may comprise any of the materials discussed above with respect to the top layer 114. The bottom layer 122 may be minimal (i.e., span a limited length and width of the antenna), maximal (i.e., span a maximum length and width of the antenna), or have metal patterns removed therefrom.

The antenna 100 is further depicted as including a plurality of dielectric layers 118 positioned between some of the layers of the antenna 100. Particularly, a dielectric layer 118 is depicted as being provided between the top layer 114 and the intermediate layer 116 and another dielectric layer 118 is depicted as being provided between the intermediate layer 116 and the bottom layer 122. As such, a dielectric layer 118 is provided between each of the metal layers in the antenna 100. In any regard, the dielectric layers 118 may be formed of a flexible material having a relatively low-dielectric constant. For example, the dielectric layer 118 is formed of an air-filled low dielectric-constant low-loss plastic foam. By way of particular example, the dielectric layer 118 is formed of a double stick foam tape for maintaining metal layer separation (i.e., distances between the top layer 114, the intermediate layer 116, and the bottom layer 122. In other examples, the dielectric layer 118 is formed of aerogel, flexible plastic, glass, a hard plastic material, flexible specialty glass dielectric, etc. The use of the glass or hard plastic material may limit the flexibility of the antenna 100.

As also shown in FIG. 1A, an optional film layer 128 is depicted as being provided above the top layer 114. The film layer 128 may be composed of any suitable flexible material, such as a flexible plastic material. In addition, the film layer 128 may be transparent, translucent or formed of a transparent or non-transparent colored film. Further, the film layer 128 may include an artistic design pattern. If the film layer 128 includes a mirror configuration, the film may be stiff and formed of a firm deposited material. The film layer 128 may be omitted, for example, if no artistic design pattern or color scheme is used.

An optional aesthetic layer 130 may be added on any exposed surfaces or sides of the top and/or bottom layers 114, 122, respectively, as further shown in FIG. 1A. The aesthetic layer 130 may be formed of a flexible or non-flexible plastic material, glass, and may have any suitable color and/or pattern. In other examples, the aesthetic layer 130 is formed of a transparent material and is not colored or patterned. By way of particular example, the aesthetic layer 130 is constructed to match its surrounding environment. The aesthetic layer 130 may also be omitted, for example, if no artistic design pattern or color scheme is to be used on the antenna 100.

According to an example, and as also shown in FIG. 1A, respective adhesive layers 124 are provided between the top layer 114 and a dielectric layer 118, between the dielectric layer 118 and the intermediate layer 116, between the intermediate layer 116 and another dielectric layer 118, and between the another dielectric layer 118 and the bottom layer 122. Additional adhesive layers 124 are also depicted as being provided to attach the optional the layer 128 and the optional aesthetic layer 130 to respective layers of the antenna 100. The adhesive layers 124 may comprise any suitable type of adhesive that remains flexible after bonding the respective layers together. Alternatively, the adhesive layers 124 may have limited flexibility if the antenna 100 includes the top layer 114 formed of a metal deposition layer, such as a mirror. Further, an adhesive layer 126 may be disposed on an exposed surface of the bottom section 112 for facilitating adhesion of the antenna 100 to a flat or contoured surface of an object (not shown). For example, the adhesive layer 126 may facilitate adhesion of the antenna 100 to a flat or contoured wall, a television or any other suitable flat or contoured structure. By way of particular example, the adhesive layer 126 facilitates adhesion of the antenna 100 to an outer surface of an antenna access point.

According to another example, and as shown in FIG. 1B, at least one of the top layer 114, the dielectric layers 118, the intermediate layer 116, and the bottom layer 122 may be attached to each other without use of the adhesive layers 124. For instance, the top layer 114 may be attached directly to the dielectric layer 118 through application of heat or the top layer 114 and the dielectric layer 118 may be laminated together in other manners, such as through the use of chemicals that dissolve and fuse portions of the top layer 114 and the dielectric layer 118 together. As another example, the bottom layer 122 may be directly attached to a dielectric layer 118 without the use of adhesives. In addition, or alternatively, the top layer 114 may be attached to the film layer 126 and/or the aesthetic layer 130 without the use of adhesives.

According to an example, the top, intermediate and bottom layers 114, 116 and 122, respectively, may be formed of a metallic paint and painted onto the adjacent dielectric layer surface. For this configuration, the metallic paint may include an adhesive provided therein for attachment to the adjacent dielectric layer surface in a similar manner as shown in FIG. 1B. The metallic paint with adhesive, or without adhesive may replace one or all of the foregoing metal and adhesive layers.

As a further example, at least some of the layers forming the antenna 100 may not be attached or adhered to each other. Instead, the layers of the antenna 100 may be positioned in a stacked arrangement and a mechanical structure (not shown) may be implemented to maintain the stacked arrangement of the antenna 100 layers. In this example, a mechanical structure that does not substantially interfere with the operations of or substantially restrict the flexibility of the antenna 100 may be employed. By way of example, the mechanical structure may also be composed of a flexible material and may bind the layers together through openings (not shown) in the layers and/or as a casing around the layers.

As a yet further example, and as shown in FIG. 1C, the top layer 114 and a dielectric layer 118 may comprise a combined layer 140 formed of, for instance, a metal-impregnated or metalized fabric material. Additionally, the bottom layer 124 and a dielectric layer 118 may comprise a combined layer 142, which may also be formed of a metal-impregnated or metalized fabric material. Furthermore, the intermediate layer 116 and dielectric layer 118 may similarly be formed into a combined layer (not shown).

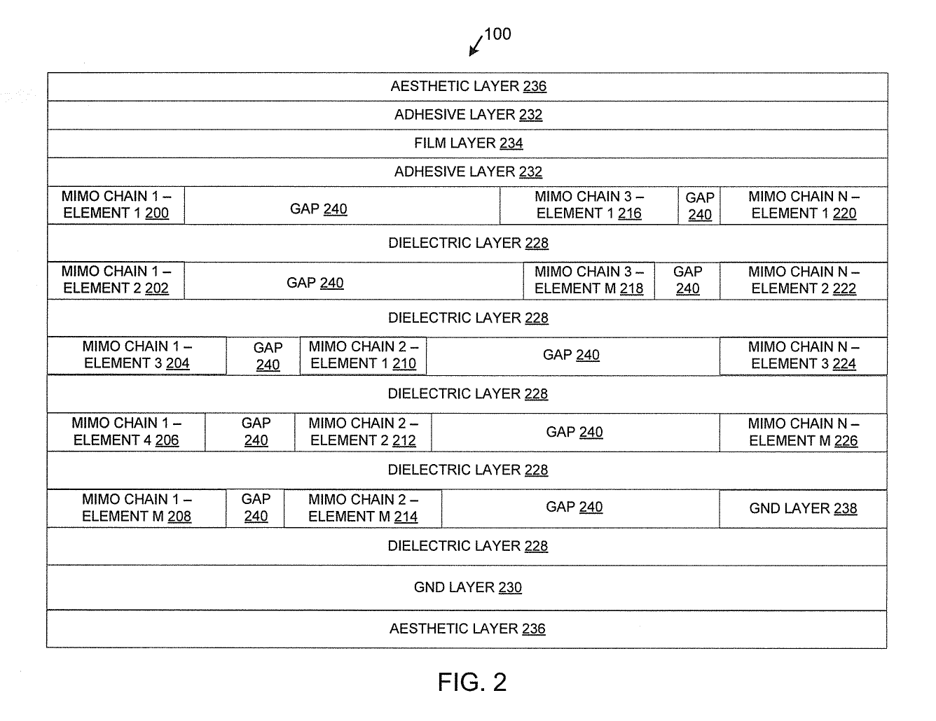

The foregoing various layers of the antenna 100 may form a multiple-input, multiple-output (MIMO) chain, multiple single-input, single-output (SISO) antennas, multiple active elements, or multiple frequency band elements, of a MIMO or SISO antenna, as described in further detail below with reference to FIGS. 2-8F. For example, the top layer 114 of the antenna 100 may form a corresponding MIMO chain, a SISO antenna or a frequency band element. Further, the intermediate layers 116 of the antenna 100 may form a MIMO chain, a SISO antenna or frequency band element. In this manner, layer n of the antenna 100 may form a corresponding MIMO chain n, a SISO antenna n or frequency band element n. In addition, each of the layers 114, 116 . . . n, may include a corresponding coaxial cable, or use a multiconductor coaxial cable.

According to an example, the antenna 100 is fabricated by providing the bottom layer 122, attaching a dielectric layer 118 onto the bottom layer 122, attaching a active layer 114 over the electric layer 118, forming an antenna element on the active layer 114, and attaching a film layer 128 over the active layer 114. In addition, an intermediate layer 116 may be provided between the bottom layer 122 and the active (top) layer 114 and an aesthetic layer 130 may be attached to the antenna 100. In other examples, however, at least one of the layers 122, 128 and 130 may be omitted.

Referring to FIG. 2, an architecture of the antenna 100 including multiple-input multiple-output (MIMO) chains is illustrated, according to an example of the present disclosure. Although not shown, at least some of the layers of the antenna 100 may be attached to each other through use of adhesives, for instance, as discussed above with respect to FIG. 1A, and/or through application of heat or use of other mechanical structures, for instance, as discussed above with respect to FIG. 1B.

The antenna 100 is depicted as including a MIMO chain 1 at 200 corresponding to an element 1, the MIMO chain 1 at 202 corresponding to an element 2, the MIMO chain 1 at 204 corresponding to an element 3, the MIMO chain 1 at 206 corresponding to an element 4, and the MIMO chain 1 at 208 corresponding to an element m. The antenna 100 is further depicted as including a MIMO chain 2 at 210 corresponding to the element 1, the MIMO chain 2 at 212 corresponding to the element 2, and the MIMO chain 2 at 214 corresponding to the element m. The antenna 100 is still further depicted as including a MIMO chain 3 at 216 corresponding to the element 1 and the MIMO chain 3 at 218 corresponding to the element m.

In addition, the antenna 100 is depicted as including a MIMO chain n at 220 corresponding to the element 1, the MIMO chain n at 222 corresponding to the element 2, the MIMO chain n at 224 corresponding to the element 3, and the MIMO chain n at 226 corresponding to the element m.

Various layers, such as a dielectric layer 228, ground layer 230, adhesive layer 232, film layer 234, and aesthetic layer 236, may be formed in a similar manner as the corresponding layers shown in FIG. 1A. Further, the ground layer 230 may alternatively be provided between two of the higher layers of the antenna 100, for instance, as shown as ground layer 238. The sizes of the various MIMO chains may also vary as shown in FIG. 2. For example, the MIMO chains 1 corresponding to elements 1-m may be formed of the same or different sizes (e.g., see same size at 200 and 202, and different sizes at 204 and 206). The MIMO chains may also include gaps 240 of varying length.

The MIMO chains of a MIMO antenna structure may be formed, for instance, in the top layer 114 and the intermediate layers 116, as shown in FIGS. 1A-1C, and may operate as active antenna elements in the antenna 100. In addition, at least some of the MIMO chains may operate at different frequencies with respect to each other. For instance, the MIMO chains in one half of the antenna 100 may operate in the 2.4 GHz frequency and the MIMO chains in the other half of the antenna may operate in the 5-6 GHz frequencies. In one regard, for instance, the MIMO chains may include various patterns, as discussed in greater detail herein below.

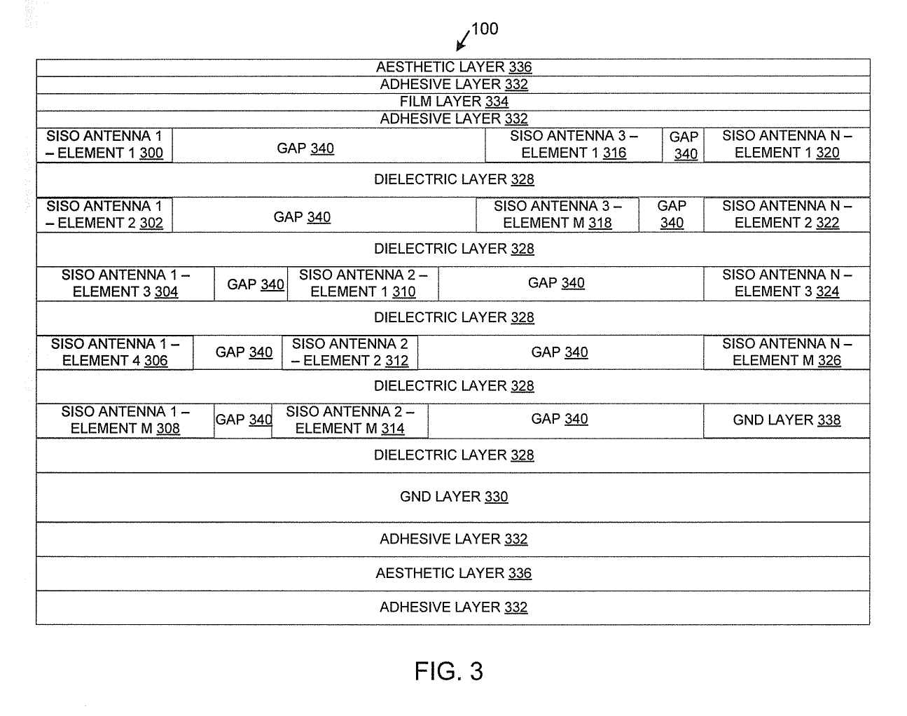

Referring to FIG. 3, an architecture of the antenna 100 including single-input, single-output (SISO) antennas is illustrated, according to an example of the present disclosure. Although not shown, at least some of the layers of the antenna 100 may be attached to each other through use of adhesives, for instance, as discussed above with respect to FIG. 1A, and/or through application heat or use of other mechanical structures, for instance, as discussed above with respect to FIG. 1B.

The antenna 100 is depicted as including a SISO antenna 1 at 300 corresponding to an element 1, the SISO antenna 1 at 302 corresponding to an element 2, the SISO antenna 1 at 304 corresponding to an element 3, the SISO antenna 1 at 306 corresponding to an element 4, and the SISO antenna 1 at 308 corresponding to an element m. The antenna 100 is also depicted as including a SISO antenna 2 at 310 corresponding to the element 1, the SISO antenna 2 at 312 corresponding to the element 2, and the SISO antenna 2 at 314 corresponding to the element m. The antenna 100 is further depicted as including the SISO antenna 3 at 316 corresponding to the element 1, and the SISO antenna 3 at 318 corresponding to the element m.

In addition, the antenna 100 is depicted as including a SISO antenna n at 320 corresponding to the element 1, the SISO antenna n at 322 corresponding to the element 2, the SISO antenna n at 324 corresponding to the element 3, and generally, the SISO antenna n at 326 corresponding to the element m.

Various layers, such as a dielectric layer 328, ground layer 330, adhesive layer 332, film layer 334, and aesthetic layer 336, may be formed in a similar manner as the corresponding layers shown in FIG. 1A. Further, the ground layer 330 may alternatively be provided between two of the higher layers of the antenna 100, for instance, as shown as ground layer 338. The sizes of the various SISO antennas may also vary as shown in FIG. 3. For example, the SISO antennas 1 corresponding to elements 1-m may be formed of the same or different sizes (e.g., see same size at 300 and 302, and different sizes at 304 and 306). The SISO antennas may also include gaps 340 of varying length.

The SISO antennas may be formed, for instance, in the top layer 114 and the intermediate layers 116, as shown in FIGS. 1A-1C, and may operate as active antenna elements in the antenna 100. In addition, at least some of the SISO antennas may operate at different frequencies with respect to each other. For instance, the SISO antennas in one half of the antenna 100 may operate in the 2.4 GHz frequency and the SISO antennas in the other half of the antenna may operate in the 5-6 GHz frequencies. In one regard, for instance, the SISO antennas may include various patterns, as discussed in greater detail herein below.

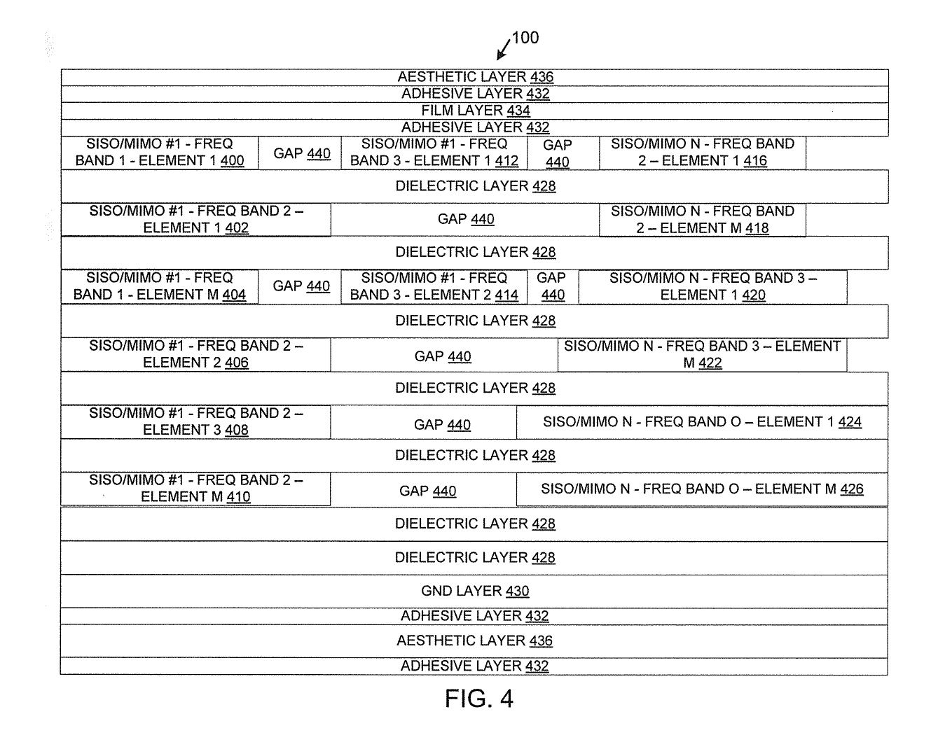

Referring to FIG. 4, an architecture of the antenna 100 that is to operate at multiple frequency bands is illustrated, according to an example of the present disclosure. Although not shown, at least some of the layers of the antenna 100 may be attached to each other through use of adhesives, for instance, as discussed above with respect to FIG. 1A, and/or through application heat or use of other mechanical structures, for instance, as discussed above with respect to FIG. 1B.

The antenna 100 is depicted as including a SISO/MIMO chain 1 (i.e., SISO antenna 1 or MIMO chain 1) at 400 corresponding to a frequency band 1 and an element 1, the SISO/MIMO chain 1 at 402 corresponding to a frequency band 2 and the element 1, and the SISO/MIMO chain 1 at 404 corresponding to the frequency band 1 and an element m. The antenna 100 is also depicted as including the SISO/MIMO chain 1 at 406 corresponding to the frequency band 2 and an element 2, the SISO/MIMO chain 1 at 408 corresponding to the frequency band 2 and an element 3, and the SISO/MIMO chain 1 at 410 corresponding to the frequency band 2 and the element m. The antenna 100 is further depicted as including the SISO/MIMO chain 1 at 412 corresponding to a frequency band 3 and the element 1, and the SISO/MIMO chain 1 at 414 corresponding to the frequency band 3 and an element 2.

In this manner, the antenna 100 is depicted as including a SISO/MIMO chain n at 416 corresponding to the frequency band 2 and the element 1. The antenna 100 may further include the SISO/MIMO chain n at 418 corresponding to the frequency band 2 and the element m, the SISO/MIMO chain n at 420 corresponding to the frequency band 3 and the element 1, the SISO/MIMO chain n at 422 corresponding to the frequency band 3 and the element m, the SISO/MIMO chain n at 424 corresponding to the frequency band o and the element 1, and generally, the SISO/MIMO chain n at 426 corresponding to frequency band o and the element m.

Various layers, such as a dielectric layer 428, ground layer 430, adhesive layer 432, film layer 434, and aesthetic layer 436, may be formed in a similar manner as the corresponding layers shown in FIG. 1A. Further, the ground layer 430 may alternatively be provided between two of the higher layers of the antenna 100. The sizes of the various SISO/MIMO chains may also vary as shown in FIG. 4. For example, the SISO/MIMO chains 1 at 400, 402 and 404 may be formed of the same or different sizes. The SISO/MIMO chains may also include gaps 440 of varying length.

The SISO/MIMO chains may be formed, for instance, in the top layer 114 and the intermediate layers 116, as shown in FIGS. 1A-1C, and may operate as active antenna elements in the antenna 100. In addition, at least some of the SISO/MIMO chains may operate at different frequencies with respect to each other. For instance, the SISO/MIMO chains in one half of the antenna 100 may operate in the 2.4 GHz frequency and the SISO antennas in the other half of the antenna may operate in the 5-6 GHz frequencies. In one regard, for instance, the SISO/MIMO chain may include various patterns, as discussed in greater detail herein below.

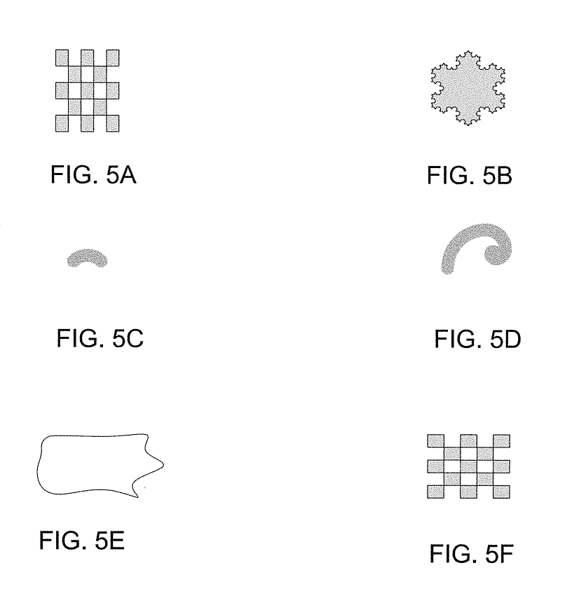

Referring to FIGS. 5A-5F, architectures of the active antenna elements of the antenna 100 depicted in any FIGS. 2-4 are illustrated, according to an example of the present disclosure. As shown in FIGS. 5A-5F, any of the active antenna elements may include any of a variety of different shapes and/or patterns. In addition, although particular shapes and patterns have been depicted in FIGS. 5A-5F, it should be clearly understood that the active antenna elements may comprise various other shapes and/or patterns without departing from a scope of the antenna 100 disclosed herein.

The configuration of FIG. 5A represents a repeated pattern shape. Generally, an element (e.g., element 1) of the antenna 100 may include an arbitrary closed shape (e.g., a polygon, smooth curve, jagged outline, fractal shape etc.). Other arbitrary closed shapes are discussed below with reference to FIGS. 5B-5F. The configuration of FIG. 5B represents a fractal shape. For example, the configuration of FIG. 5B may represent a SISO antenna n, or MIMO chain n, at frequency band 1, for example, as discussed with reference to FIGS. 2-4.

The configuration of FIG. 5C represents a smooth curve. For example, the configuration of FIG. 5C may represent a SISO antenna 4, or MIMO chain 4, at frequency band 1, for example, as discussed with reference to FIGS. 2-4. Similarly, the configuration of FIG. 5D may represent a mathematical shape (e.g., a logarithmic spiral). For example, the configuration of FIG. 5D may represent a SISO antenna 4, or MIMO chain 4, at frequency band 1. The configuration of FIG. 5E represents a closed shape. For example, the configuration of FIG. 5E may represent a SISO antenna 1, or MIMO chain 1, at frequency band 1.

The configuration of FIG. 5F represents a rotated repeated pattern shape, compared to the configuration of FIG. 5A. The rotation (e.g., at 90°) may maximize the orthogonality and isolation between elements. The rotation angle may be changed to maximize the isolation between elements. For example, the configuration of FIG. 5F may represent a SISO antenna 2, or MIMO chain 2, at frequency band 1, for example, as discussed with reference to FIGS. 2-4.

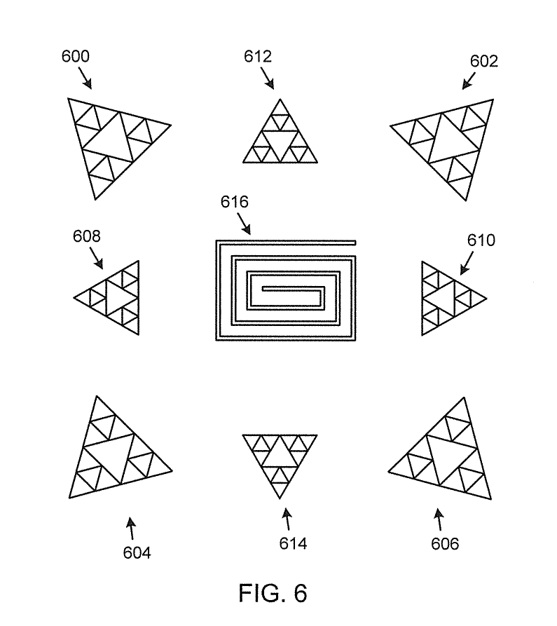

Referring to FIG. 6, architectures of the active antenna elements of the antenna 100 depicted in any of FIGS. 2-4 including various fractal patterns are illustrated, according to an example of the present disclosure. Although particular fractal patterns have been depicted in FIG. 6, it should be clearly understood that the active antenna elements may comprise various other fractal patterns without departing from a scope of the antenna 100 disclosed herein.

For the example of FIG. 6, fractals may be represented by triangles within triangles, with some triangles filled with metal or other material as discussed herein. The triangles at corners 600, 602, 604 and 606 may represent maximal distance elements. Thus, isolation between antenna elements may be increased by maximizing the distance between antenna elements. Further, the active antenna elements may be arrayed around a perimeter to maximize isolation, maximize symmetry, and/or to cover different directions. For example, opposing triangles 600, 606 (or 602, 604) may be rotated at 180° from each other, for maximum isolation. The larger corner triangles 600, 602, 604 and 606 may be lower frequency band antennas compared to smaller triangles 608, 610, 612 and 614. Thus, comparing the larger corner triangles 600, 602, 604 and 606, and the smaller triangles 608, 610, 612 and 614, the larger and smaller triangles are shown as interleaved to further increase isolation and distance between elements in the same frequency band (e.g., between the larger corner triangles 600, 602, 604 and 606, or between the smaller triangles 608, 610, 612 and 614).

The active antenna elements may be made to be similar across chains, or SISO antennas, in order to maintain similar performance and/or coverage symmetry. For example, referring to FIG. 6, the larger corner triangles 600, 602, 604 and 606, or the smaller triangles 608, 610, 612 and 614 are made of a similar shape for maintaining similar performance. Further, as shown for the antenna pattern at 616, elements may be made totally dissimilar in order to create intentionally different antenna patterns, make the signals take intentionally different paths over the air, or cover different frequency bands.

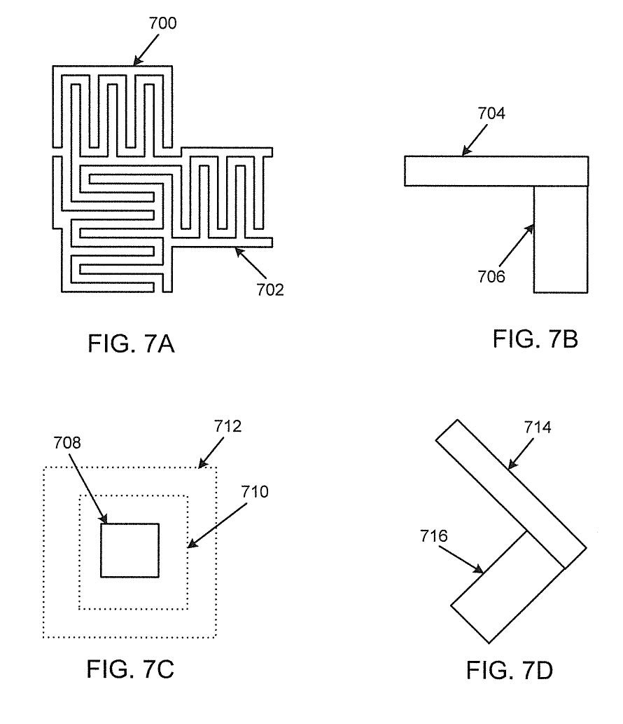

Referring to FIGS. 7A-7D, architectures of the active antenna elements of the antenna 100 depicted in any of FIGS. 2-4 including various interleaved, orthogonal and stacked configurations are illustrated, according to an example of the present disclosure. Although particular configurations have been depicted in FIGS. 7A-7D, it should be clearly understood that the active antenna elements may comprise various other configurations without departing from a scope of the antenna 100 disclosed herein.

The configuration of FIG. 7A represents interleaved elements 700, 701, 702 and 703, for example, with SISO antenna 1, or MIMO chain 1, at frequency bands 1, 2, 3 and 4, for example, as discussed with reference to FIGS. 2-4.

The configuration of FIG. 7B represents joined orthogonal elements 704 and 706, for example, with SISO antennas 1 and 2 at 704 and 706, respectively, or MIMO chain 1, at frequency band 1, for example, as discussed with reference to FIGS. 2-4.

The configuration of FIG. 7C represents vertically stacked elements 708, 710 and 712, for example, with SISO antenna 1, or MIMO chain 1, at frequency bands 5, 6 and 7, for example, as discussed with reference to FIGS. 2-4. Thus, antenna elements covering different frequency bands may be stacked vertically as shown.

The configuration of FIG. 7D represents joined orthogonal elements 714 and 716, for example, with SISO antennas 1 and 2 at 714 and 716, respectively, or MIMO chain 1, at frequency band 3 and 4, for example, as discussed with reference to FIGS. 2-4.

Active antenna elements covering different frequency bands may also be placed in different horizontal areas. For example, as shown in FIGS. 7B and 7D, the joined orthogonal elements show how the active antenna elements covering different frequency bands may be placed in different horizontal areas. For example, for FIG. 7B, antenna element 704 covers a different frequency band compared to antenna element 706 based on the different shapes of the antenna elements. Likewise, for FIG. 7D, antenna element 714 covers a different frequency band compared to antenna element 716 based on the different shapes of the antenna elements. Thus, antenna elements covering different frequency bands may be connected directly to each other in an orthogonal manner, allowing both elements to be driven at once, but in different frequency ranges. Further, antenna elements connected to different switched SISO antennas may be connected directly to each other, in an orthogonal manner, allowing a different pattern to emerge upon switching SISO antennas, but conserving space.

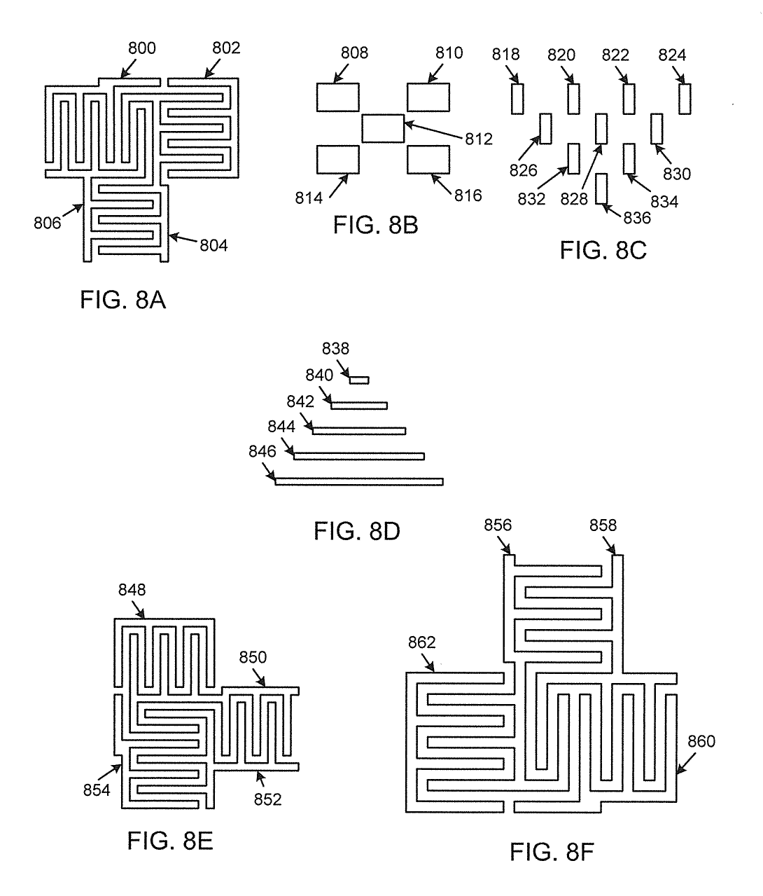

Referring to FIGS. 8A-8F, architectures of the active antenna elements of the antenna 100 depicted in any of FIGS. 2-4 including various interleaved configurations are illustrated, according to an example of the present disclosure. Although particular configurations have been depicted in FIGS. 8A-8F, it should be clearly understood that the active antenna elements may comprise various other configurations without departing from a scope of the antenna 100 disclosed herein.

The configuration of FIG. 8A represents interleaved elements 800, 802, 804 and 806, for example, with SISO antenna 1, 2, 3 and 4 at 800, 802, 804 and 806, respectively, at frequency band 1, for example, as discussed with reference to FIGS. 2-4. Thus, the configuration of FIG. 8A shows that two or more antenna elements from different MIMO chains or different SISO switched antennas may be interleaved, while still providing isolation and orthogonality.

The configuration of FIG. 8B represents interleaved elements 808, 810, 812, 814 and 816, for example, with MIMO chains 1, 2, 3, 4 and 5 at 808, 810, 812, 814 and 816, respectively, at frequency band 1, for example, as discussed with reference to FIGS. 2-4.

The configuration of FIG. 8C represents interleaved elements 818, 820, 822, 824, 826, 828, 830, 832, 834 and 836, for example, with SISO antennas 1 and 2, at frequency bands 1, 2, 3, 4 and 5, respectively, for the elements 818, 820, 822, 824, 826, 828, 830, 832, 834 and 836, for example, as discussed with reference to FIGS. 2-4. Thus, the configuration of FIG. 8C shows that two or more antenna elements from the same MIMO chains or same SISO switched antennas may be interleaved. Further, antenna elements from multiple frequency bands may be interleaved on the same layer. Further, combinations of MIMO chains and SISO switched antennas, frequency bands and element numbers may be interleaved as well, while still providing isolation and orthogonality.

The configuration of FIG. 8D represents interleaved elements 838, 840, 842, 844 and 846, for example, with MIMO chain 2, at frequency bands 1, 2, 3, 4 and 5, respectively, for elements 838, 840, 842, 844 and 846, for example, as discussed with reference to FIGS. 2-4. Thus, the configuration of FIG. 8D shows that two or more antenna elements from different MIMO chains or different SISO switched antennas may be interleaved, while still providing isolation and orthogonality. Further, antenna elements from multiple frequency bands may be interleaved on the same layer.

The configuration of FIG. 8E represents interleaved elements 848, 850, 852 and 854, for example, with SISO antenna 1, at frequency bands 1, 2, 3 and 4, respectively, for elements 848, 850, 852 and 854, for example, as discussed with reference to FIGS. 2-4. Thus, the configuration of FIG. 8E shows that there may be one or more antenna elements from a MIMO chain or SISO switched antenna on the same layer.

The configuration of FIG. 8F represents interleaved elements 856, 858, 860 and 862, for example, with MIMO chains 1, 2, 3 and 4 at 856, 858, 860 and 862, respectively, at frequency band 1, for example, as discussed with reference to FIGS. 2-4. Thus, the configuration of FIG. 8F shows that two or more antenna elements from different MIMO chains or different SISO switched antennas may be interleaved, while still providing isolation and orthogonality.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An antenna comprising:
an active antenna layer;
a ground layer; and
a dielectric layer sandwiched between the active antenna and the ground layers,
wherein the antenna is bendable to conform to a contour of a surface on which the antenna is positioned.

2. The antenna of claim 1, wherein the active antenna layer and the ground layer are formed of a material selected from the group consisting essentially of brass and copper mylar.

3. The antenna of claim 1, wherein the active antenna layer includes at least one of a fractal pattern and an interleaved pattern formed thereon.

4. The antenna of claim 1, wherein the dielectric layer is formed of a material selected from the group essentially consisting of an air-filled low dielectric-constant low-loss plastic foam, a glass, an aerogel, and a flexible specialty glass dielectric.

5. The antenna of claim 1, wherein the active antenna layer and the ground layer are attached to the active antenna layer.

6. The antenna of claim 1, further comprising an aesthetic layer disposed on an exposed surface of the antenna, wherein the aesthetic layer is formed of a transparent material.

7. The antenna of claim 1, wherein the active antenna layer and the dielectric layer comprise at least one of a combination layer formed of a metal-impregnated material and metallic paint.

8. The antenna of claim 1, wherein the active antenna layer is to operate at a plurality of frequency bands.

9. The antenna of claim 1, wherein the active antenna layer includes a plurality of multiple-input and multiple-output (MIMO) chains.

10. The antenna of claim 1, wherein the active antenna layer includes a plurality of single-input and single-output (SISO) antennas.

11. The antenna of claim 1, further comprising an intermediate layer including a multiple-input and multiple-output (MIMO) chain, a single-input and single-output (SISO) antenna or a frequency band antenna element, wherein the immediate layer is positioned between the active antenna layer and the ground layer.

12. The antenna of claim 1, wherein the active antenna layer forms a multiple-input and multiple-output (MIMO) chain, a single-input and single-output (SISO) antenna or a frequency band antenna element, and wherein the MIMO chain and SISO antenna are of different sizes, and the frequency band antenna element is to operate at a plurality of frequency bands.

13. The antenna of claim 12, further comprising gaps of different lengths between the MIMO chains or SISO antennas.

14. An antenna comprising:
an active antenna layer forming a multiple-input and multiple-output (MIMO) chain, a single-input and single-output (SISO) antenna or a frequency band antenna element;
a ground layer; and
a dielectric layer sandwiched between the active antenna and the ground layers.

15. A method of fabricating a flexible antenna, said method comprising:
providing a flexible bottom layer;
flexibly attaching a flexible dielectric layer onto the flexible bottom layer;
flexibly attaching a flexible active layer over the flexible dielectric layer;
forming an antenna pattern on the flexible active layer; and
flexibly attaching a film layer over the flexible active layer.
